(19) United States
(12) Patent Application Publication
(10) Pub. No.: US 2012/0169724 A1
(43) Pub. Date: Jul. 5, 2012

(54) APPARATUS AND METHOD FOR ADAPTIVELY RENDERING SUBPIXEL

(75) Inventors: Ju Yong Park, Seoul (KR); Gee Young Sung, Suseong-gu (KR); Dong Kyung Nam, Yongin-si (KR); Yun Tae Kim, Hwaseong-si (KR)

(73) Assignee: SAMSUNG ELECTRONICS.CO., LTD, Suwon-si (KR)

(21) Appl. No.: 13/333,368

(22) Filed: Dec. 21, 2011

(30) Foreign Application Priority Data
Dec. 29, 2010 (KR) 10-2010-0137698

(51) Int. Cl. G06F 3/033; G06T 15/00

(52) U.S. Cl. 345/419

(57) ABSTRACT

A rendering apparatus and method in a light field display may determine positions of eyes of a user, may determine a subpixel emitting a ray that enters the eyes, based on the positions of the eyes, among a plurality of subpixels forming a three-dimensional (3D) pixel, and may display a stereoscopic image on the light field display based on a pixel value of the determined subpixel.

### CROSS-REFERENCE TO RELATED APPLICATIONS

This application claims the priority benefit of Korean Patent Application No. 10-2010-0137698, filed on Dec. 29, 2010, in the Korean Intellectual Property Office, the disclosure of which is incorporated herein by reference.

### BACKGROUND

1. Field

Example embodiments of the following description relate to a general display, for example, a television (TV), a monitor, a display of a portable device, a display for advertisement, a display for education, and the like. More particularly, example embodiments of the following description relate to rendering subpixels in a light field display to reproduce and display a stereoscopic image without fatigue when viewing the stereoscopic image.

2. Description of the Related Art

A three-dimensional (3D) image display apparatus may provide different images based on a difference in viewpoint between a left eye and a right eye of a viewer, so that the viewer may feel a 3D effect.

In the 3D image display apparatus, a glass type 3D display process and a glassless type 3D display process exist. The glass type 3D display process may be used to perform filtering on a desired image by using a division using a polarized light, a time sharing, a wavelength division enabling primary colors to have different wavelengths, and the like. Additionally, the glassless type 3D display process may enable each image to be viewed only in a predetermined space using a parallax barrier or lenticular lens.

In particular, the glassless type 3D display process may include, for example, a multi-view process, and a light field process. The light field process may be used to represent lights emitted in different directions from points existing in a predetermined space without any change.

However, in the light field process, it is difficult to represent a stereoscopic image, when rays representing lights in different directions are not sufficiently ensured. Additionally, a resolution may be reduced, as a number of rays is increased.

Further, when a gap between rays is not narrow, that is, is equal to or less than a predetermined level, it is difficult to realize natural motion parallax. However, to widen a view area while maintaining the gap between the rays to be equal to or less than the predetermined level, the number of rays needs to be increased, so that the resolution may be reduced again.

Accordingly, there is a desire for a rendering technique that may widen a view area while preventing a decrease in resolution in a light field display.

### SUMMARY

The foregoing and/or other aspects are achieved by providing a subpixel rendering apparatus including a position determination unit to determine positions of eyes of a user, and a subpixel determination unit to determine, based on the positions of the eyes, a subpixel, among a plurality of subpixels forming a three-dimensional (3D) pixel, the subpixel emitting a ray that enters the eyes.

The subpixel rendering apparatus may further include a content determination unit to determine a content based on horizontal direction information and vertical direction information of a virtual line connecting the 3D pixel to the eyes, the content being displayed on a light field display, and a pixel value determination unit to determine a pixel value of the determined subpixel, using the determined subpixel and the determined content.

The subpixel rendering apparatus may further include a crosstalk processing unit to reduce a crosstalk between the determined subpixel and the other subpixels.

The subpixel rendering apparatus may further include at least one camera to capture the positions of the eyes.

The subpixel determination unit may determine the subpixel in parallel for each 3D pixel.

The foregoing and/or other aspects are achieved by providing a subpixel rendering method including determining, by a processor, positions of eyes of a user, and determining, based on the positions of the eyes, a subpixel among a plurality of subpixels forming a 3D pixel, the subpixel emitting a ray that enters the eyes.

The subpixel rendering method may further include determining a content based on horizontal direction information and vertical direction information of a virtual line connecting the 3D pixel to the eyes, the content being displayed on a light field display, and determining a pixel value of the determined subpixel, using the determined subpixel and the determined content.

The subpixel rendering method may further include reducing a crosstalk between the determined subpixel and the other subpixels.

The subpixel rendering method may further include capturing the positions of the eyes using at least one camera.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a diagram of a light field display system, to explain an overall operation of a rendering apparatus for determining subpixels corresponding to positions of eyes of a user in connection with a camera according to example embodiments;

FIG. 2 illustrates a diagram of a light field display for generating rays in different directions in a three-dimension (3D) according to example embodiments;

FIG. 3 illustrates a diagram of rays that emanates from a 3D pixel to reach both eyes of a user when only a horizontal direction is considered, according to example embodiments;

FIG. 4 illustrates a diagram of a brightness distribution of each view in a 12-view display for each subpixel according to example embodiments;

FIG. 5 illustrates a block diagram of a configuration of a rendering apparatus for displaying a stereoscopic image on a light field display according to example embodiments;

FIG. 6 illustrates a diagram of an operation of calculating a horizontal direction slope and a vertical direction slope according to example embodiments; and

FIG. 7 illustrates a flowchart of a rendering method for displaying a stereoscopic image using a subpixel determined based on positions of eyes of a user according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

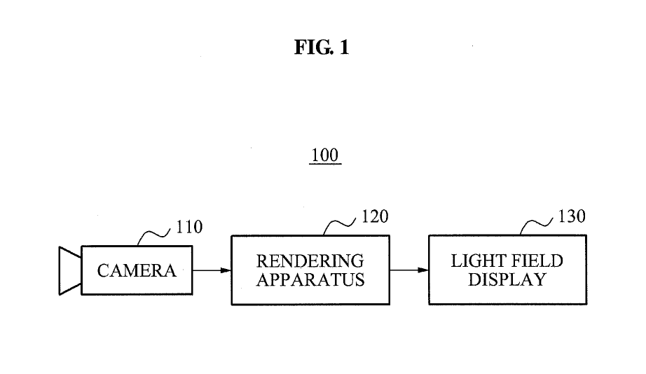

FIG. 1 illustrates a diagram of a light field display system 100, to explain an overall operation of a rendering apparatus to determine subpixels corresponding to positions of eyes of a user in connection with a camera according to example embodiments.

Referring to FIG. 1, the light field display system 100 may include a camera 110, a rendering apparatus 120, and a light field display 130.

The camera 110 may capture positions of eyes of a user that stares the light field display 130. The camera 110 may include, for example, at least one visible spectrum camera, at least one infrared camera, and at least one depth camera. Additionally, the camera 110 may be inserted into the light field display 130, or may be detached from or attached to the light field display 130.

The rendering apparatus 120 may determine position coordinate values of the eyes in a space coordinate, based on the positions of the eyes captured by the camera 110. Additionally, the rendering apparatus 120 may determine subpixels corresponding to the position coordinate values of the eyes. That is, the rendering apparatus 120 may determine subpixels on the light field display 130 at which the eyes of the user stare.

Additionally, the rendering apparatus 120 may determine a content to be displayed on the light field display 130, based on the positions of the eyes. Moreover, the rendering apparatus 120 may determine pixel values of the determined subpixels based on the determined content and the determined subpixels. The light field display 130 may generate rays based on the determined pixel values, to display a stereoscopic image.

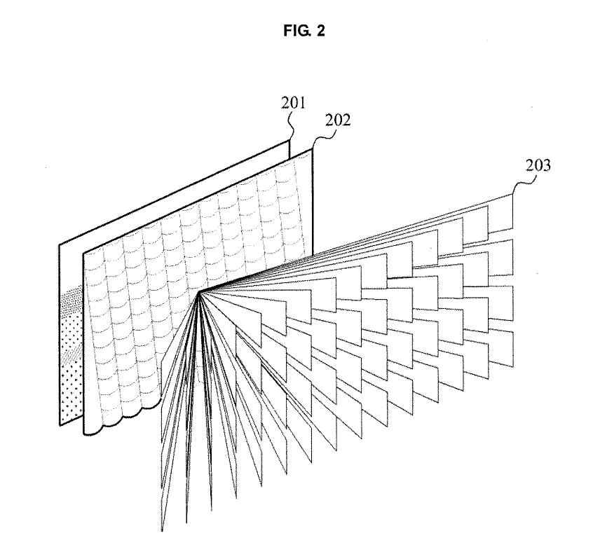

FIG. 2 illustrates a diagram of a light field display 201 to generate rays in different directions in a three-dimension (3D) according to example embodiments.

Referring to FIG. 2, the light field display 201 may include a plurality of 3D pixels. Additionally, a single 3D pixel 202 may include a plurality of subpixels 203.

For example, a single 3D pixel 202 may include “15×4” subpixels 203. In this example, the 3D pixel may emit rays in “15×4” directions using the “15×4” subpixels. Accordingly, 3D pixels may be collected, and points in 3D space may be displayed on the light field display.

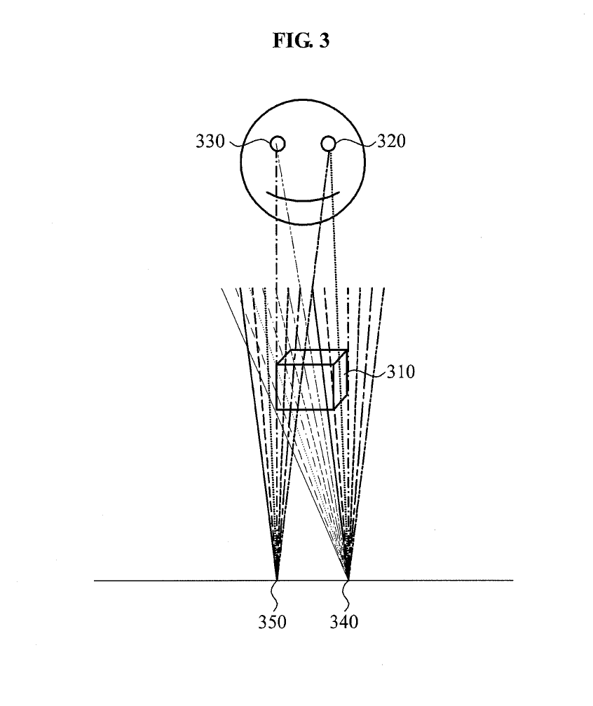

FIG. 3 illustrates a diagram of rays that emanates from a 3D pixel to reach both eyes of a user when only a horizontal direction is considered, according to example embodiments.

In FIG. 3, when both a left eye 320 and a right eye 330 of the user stare at an object 310, a 3D pixel 340 corresponding to the left eye 320 may emit rays in different directions. Similarly, a 3D pixel 350 corresponding to the right eye 330 may emit rays in different directions.

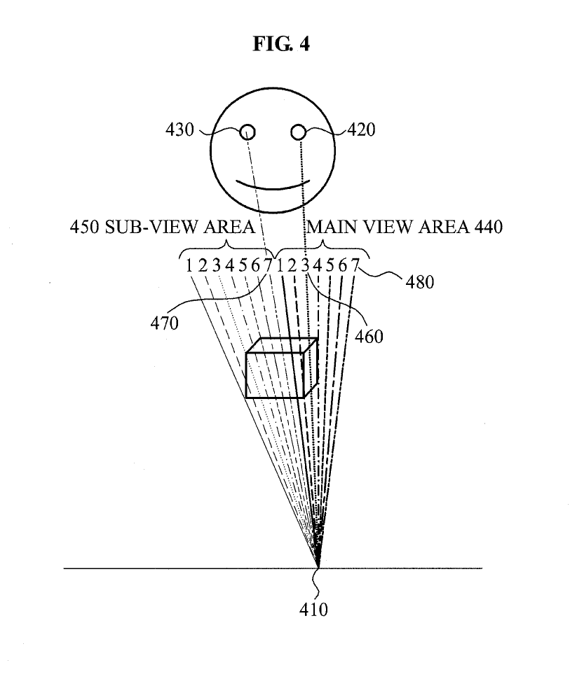

As shown in FIG. 4, based on rays that emanate from a single 3D pixel 410 and that are viewed with a left eye 420 and a right eye 430 of a user, the left eye 420 may exist within a main view area 440, and the right eye 430 may exist within a sub-view area 450. Here, in the sub-view area 450, rays included in the main view area 440 may be repeated.

Accordingly, a rendering apparatus according to example embodiments may individually determine subpixels at which a left eye and a right eye of a user stare, among a plurality of subpixels forming a single 3D pixel, and may display, on a light field display, a natural stereoscopic image using each of the determined subpixels.

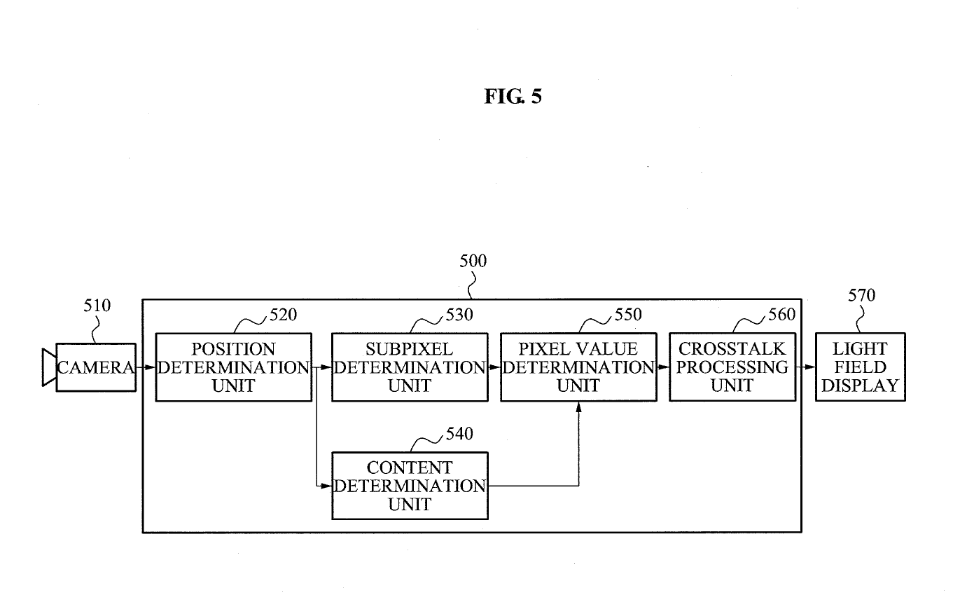

Hereinafter, an example of determining subpixels at which eyes of a user stare will be further described with reference to FIG. 5. In FIG. 5, a rendering apparatus 500 may individually determine subpixels at which a left eye and a right eye of a user stare. Here, the same process may be used to determine the subpixels at which the left eye and the right eye of the user respectively stare. Accordingly, an example of determining a subpixel at which one of both eyes of a user stares be further described below with reference to FIGS. 5 through 7.

FIG. 5 illustrates a block diagram of a configuration of the rendering apparatus 500 to display a stereoscopic image on a light field display 570 according to example embodiments.

Referring to FIG. 5, the rendering apparatus 500 may include a position determination unit 520, a subpixel determination unit 530, a content determination unit 540, pixel value determination unit 550, and a crosstalk processing unit 560.

First, a camera 510 may capture a position of an eye of a user, and may transmit the captured position to the rendering apparatus 500.

For example, the camera 510 may capture a position of an eye of a user that stares at the light field display 570, and may transmit, to the rendering apparatus 500, a sensing parameter associated with the captured positions. In this example, at least one camera may be inserted into or attached to the light field display 570.

The position determination unit 520 may determine the position of the eye based on the sensing parameter received from the camera 510. For example, the position determination unit 520 may determine, based on the sensing parameter, a position coordinate value (x, y, z) of the eye in a 3D space.

Subsequently, the subpixel determination unit 530 may determine a 3D pixel corresponding to the determined position, among a plurality of 3D pixels that form the light field display 570.

Additionally, the subpixel determination unit 530 may determine a subpixel that emits a ray to enter the eye, among a plurality of subpixels that form the determined 3D pixel. Here, the subpixel determination unit 530 may determine the subpixel in parallel for each 3D pixel. Accordingly, it is possible to improve an operation speed of the rendering apparatus 500.

Specifically, the subpixel determination unit 530 may determine the subpixel based on horizontal direction information and vertical direction information of a virtual line connecting the eye to the 3D pixel.

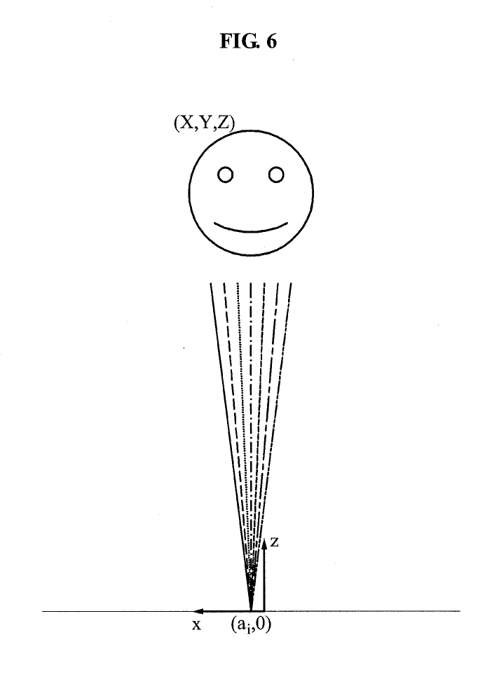

For example, when a slope is used as direction information, the subpixel determination unit 530 may calculate a horizontal direction slope of the virtual line, using a position coordinate of the eye, and a position coordinate of the 3D pixel, as shown in FIG. 6 and the following Equation 1:

$${α}_{i} = \frac{x - {a}_{i}}{z} \qquad [ Equation 1 ]$$

In Equation 1 and FIG. 6, αᵢ denotes a horizontal direction slope, (x, z) denotes a position coordinate of the eye with respect to a horizontal direction, and (aᵢ, 0) denotes a position coordinate of the 3D pixel with respect to the horizontal direction.

In the same process, the subpixel determination unit 530 may also calculate a vertical direction slope of the virtual line, using the position coordinate of the eye, and the position coordinate of the 3D pixel, as shown in FIG. 6 and the following Equation 2:

$${β}_{i} = \frac{y - {b}_{i}}{z} \qquad [ Equation 2 ]$$

In Equation 2 and FIG. 6, βᵢ denotes a vertical direction slope, (y, z) denotes a position coordinate of the eye with respect to a vertical direction, and (0, bᵢ) denotes a position coordinate of the 3D pixel with respect to the vertical direction.

Subsequently, the subpixel determination unit 530 may select a ray having a slope most similar to the horizontal direction slope and the vertical direction slope, from among rays in different directions emitted from the 3D pixel, and may determine a subpixel that emits the selected ray, as a subpixel at which the eye stares. Here, the subpixel determination unit 530 may determine a position coordinate of the determined subpixel.

For example, the subpixel determination unit 530 may determine a position coordinate of a subpixel at which the eye stares, using the following Equation 3:

pᵢ=fₚ(αᵢ,βᵢ) [Equation 3]

In Equation 3, pᵢ denotes a position coordinate of a subpixel at which the eye stares, αᵢ denotes a horizontal direction slope, βᵢ denotes a vertical direction slope, and fₚ denotes a function used to determine a subpixel.

For example, when rays in “15×4” directions are emitted from a 3D pixel as shown in FIG. 2, the subpixel determination unit 530 may select a ray having a slope identical to or most similar to the horizontal direction slope and the vertical direction slope, from among the rays in the “15×4” directions.

In this example, when the selected ray exists in a main view area, the subpixel determination unit 530 may determine a subpixel that emits the selected ray, as a subpixel at which the eye stares, among the plurality of subpixels in the 3D pixel.

Additionally, when the selected ray exists in a sub-view area, the subpixel determination unit 530 may determine a subpixel that emits a ray in a main view area corresponding to the selected ray in the sub-view area, as a subpixel at which the eye stares. For example, as shown in FIG. 4, when a ray 3 460 emitted to the left eye 420 exists in the main view area 440, and when a ray 7 470 emitted to the right eye 430 exists in the sub-view area 450, the subpixel determination unit 530 may determine a subpixel that emits a ray 7 480 in the main view area 440 corresponding to the ray 7 470 in the sub-view area 450, as a subpixel at which the right eye 430 stares. In other words, the rendering apparatus 500 may display a stereoscopic image at which the right eye 430 stares, using the subpixel emitting the ray 7 480.

The content determination unit 540 may determine a content to be displayed on the light field display 570, based on a horizontal direction slope and a vertical direction slope of a virtual line connecting the 3D pixel to the eye. Here, when a stereoscopic image is formed for each content, the content determination unit 540 may determine an index of contents to be displayed on the light field display 570.

For example, the content determination unit 540 may determine a content using the following Equation 4:

cᵢ=f_{c}(αᵢ,βᵢ) [Equation 4]

In Equation 4, cᵢ denotes an index of contents, αᵢ denotes a horizontal direction slope, βᵢ denotes a vertical direction slope, and f_{c} denotes a function used to determine a subpixel.

The pixel value determination unit 550 may determine a pixel value of the subpixel determined by the subpixel determination unit 530, using the determined content and the determined subpixel. Here, the pixel value determination unit 550 may individually determine pixel values of subpixels at which the left eye and the right eye of the user respectively stare.

For example, the pixel value determination unit 550 may determine a pixel value of a subpixel using the following Equation 5:

V(pᵢ)=V_{C}(cᵢ,pᵢ) [Equation 5]

In Equation 5, V(pᵢ) denotes a pixel value of a subpixel at which an eye of a user stares, cᵢ denotes an index of contents, and pᵢ denotes a position coordinate of the subpixel at which the eye stares.

In Equation 5, the pixel value determination unit 550 may determine a pixel value corresponding to the position coordinate of the subpixel in the determined content, as a pixel value of a subpixel at which an eye of a user stares.

The determined subpixel may emit a ray based on the pixel value of the subpixel and thus, a stereoscopic image at which the eye stares may be displayed on the light field display 570.

The crosstalk processing unit 560 may eliminate or reduce crosstalk between the determined subpixel and the other subpixels. Here, the other subpixels may be obtained by excluding the determined subpixel from the plurality of subpixels in the 3D pixel.

For example, the crosstalk processing unit 560 may set pixel values of the other subpixels to “0” and accordingly, the light field display 570 may display the ray emitted from the determined subpixel to the eye, not display rays emitted from the other subpixels. Thus, it is possible to reduce or eliminate a crosstalk that may occur in a microlens array or a barrier array.

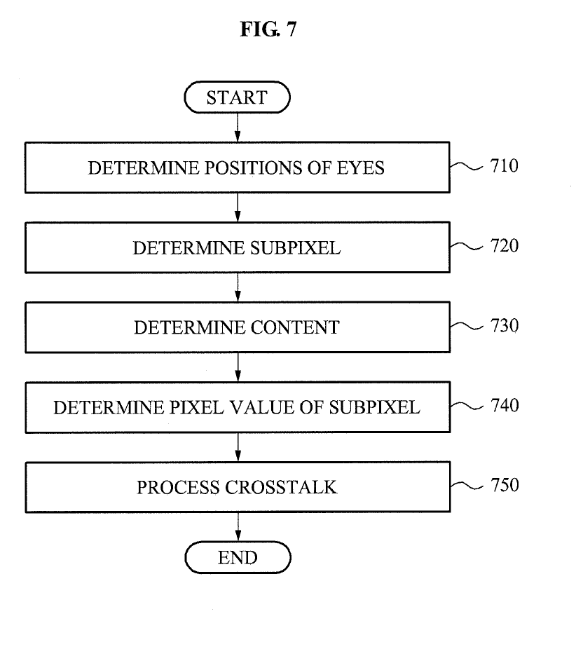

FIG. 7 illustrates a flowchart of a rendering method for displaying a stereoscopic image using a subpixel determined based on a position of an eye of a user according to example embodiments.

Referring to FIG. 7, in operation 710, the rendering apparatus may determine the position of the eye of the user based on sensing data received from at least one camera.

Specifically, the at least one camera may generate the sensing data by capturing the position of the eye in front of a light field display, and may transmit the sensing data to the rendering apparatus. In response to the sensing data, the rendering apparatus may determine a position coordinate value (x, y, z) of the eye in 3D space. For example, the rendering apparatus may determine a position coordinate value (x_{L}, y_{L}, z_{L}) of the left eye, and a position coordinate value (x_{R}, y_{R}, z_{R}) of the right eye.

In operation 720, the rendering apparatus may determine, based on the determined position of the eye, a subpixel that emits a ray to enter the eye, among a plurality of subpixels forming a 3D pixel. Specifically, the rendering apparatus may determine the subpixel in parallel for each 3D pixel.

For example, the rendering apparatus may determine a 3D pixel corresponding to the position of the eye among a plurality of 3D pixels that form a light field display. Specifically, the rendering apparatus may determine a position coordinate of the 3D pixel corresponding to the position of the eye. Additionally, the rendering apparatus may calculate a horizontal direction slope of a virtual line based on a position coordinate of the eye of the user and the position coordinate of the 3D pixel, using Equation 1 described above. Subsequently, the rendering apparatus may calculate a vertical direction slope of the virtual line based on the position coordinate of the eye and the position coordinate of the 3D pixel, using Equation 2 described above. Additionally, the rendering apparatus may determine, as a subpixel at which the eye stares, a subpixel that emits a ray having a slope most similar to the horizontal direction slope and the vertical direction slope, among the plurality of subpixels in the 3D pixel, using Equation 4 described above. In other words, the rendering apparatus may determine a position coordinate of the subpixel at which the eye stares.

In operation 730, the rendering apparatus may determine a content to be displayed on the light field display, based on horizontal direction information and vertical direction information. For example, the rendering apparatus may determine the content using Equation 4 described above.

In operation 740, the rendering apparatus may determine a pixel value of the determined subpixel, using the determined subpixel and the determined content. For example, the rendering apparatus may determine the pixel value of the subpixel using Equation 5 described above.

In operation 750, the rendering apparatus may process, namely, eliminate or reduce a crosstalk between the determined subpixel and the other subpixels, among the plurality of subpixels in the 3D pixel. Here, the other subpixels may be obtained by excluding the determined subpixel from the plurality of subpixels.

For example, the rendering apparatus may set pixel values of the other subpixels to “0” and accordingly, the light field display may display the ray emitted from the determined subpixel to the eye, not display rays emitted from the other subpixels.

Operations 720 through 750 of FIG. 7 may be performed in parallel for each 3D pixel.

For example, when a light field display has a size of “1920×1080”, and when a 3D pixel has a size of “10×10”, the rendering apparatus may determine, in parallel for each 3D pixel, subpixels emitting rays to enter both eyes of a user, using “192×108” operation processes. Additionally, a rendering apparatus may play back a stereoscopic image on a light field display, based on pixel values of the determined subpixels. Thus, the rendering apparatus may quickly play back the stereoscopic image by reducing an operation time.

In the rendering apparatus and method described above with reference to FIGS. 5 through 7, subpixels at which a right eye and a left eye of a user respectively stare may be individually determined using Equations 1 and 2. Thus, it is possible to display a stereoscopic image on a light field display using rays emitted from the determined subpixels.

As described above, according to example embodiments, it is possible to display a stereoscopic image using subpixels determined based on positions of eyes of a user and thus, it is possible to widen a viewing area while preventing a reduction in resolution.

Additionally, it is possible to eliminate or reduce a crosstalk by preventing display of unnecessary rays that do not enter eyes of a user.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

Moreover, the rendering apparatus 500, as shown in FIG. 5, may include at least one processor to execute at least one of the above-described units and methods.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A subpixel rendering apparatus, comprising:
a position determination unit to determine positions of eyes of a user; and
a subpixel determination unit to determine, based on the positions of the eyes, a subpixel, among a plurality of subpixels forming a three-dimensional (3D) pixel, the subpixel emitting a ray that enters the eyes.

2. The subpixel rendering apparatus of claim 1, wherein the subpixel determination unit determines the subpixel based on horizontal direction information and vertical direction information of a virtual line connecting the 3D pixel to the eyes.

3. The subpixel rendering apparatus of claim 2, wherein the subpixel determination unit calculates a horizontal direction slope of the virtual line and a vertical direction slope of the virtual line.

4. The subpixel rendering apparatus of claim 3, wherein the subpixel determination unit selects a ray having a slope most similar to the horizontal direction slope and the vertical direction slope, from among rays in different directions emitted from the 3D pixel, and determines a subpixel that emits the selected ray, as a subpixel at which the eye stares.

5. The subpixel rendering apparatus of claim 1, further comprising:
a content determination unit to determine a content based on horizontal direction information and vertical direction information of a virtual line connecting the 3D pixel to the eyes, the content being displayed on a light field display; and
a pixel value determination unit to determine a pixel value of the determined subpixel, using the determined subpixel and the determined content.

6. The subpixel rendering apparatus of claim 1, further comprising:
a crosstalk processing unit to reduce a crosstalk between the determined subpixel and the other subpixels, the other subpixels comprising at least one subpixel obtained by excluding the determined subpixel from the plurality of subpixels.

7. The subpixel rendering apparatus of claim 1, further comprising:
at least one camera to capture the positions of the eyes.

8. The subpixel rendering apparatus of claim 7, wherein the camera comprises at least one visible spectrum camera, at least one infrared camera, and at least one depth camera.

9. The subpixel rendering apparatus of claim 7, wherein the position determination unit determines position coordinate values of the eyes in a space coordinate, using the positions of the eyes captured by the at least one camera, and
wherein the subpixel determination unit determines the subpixel based on the determined position coordinate values, in the light field display.

10. The subpixel rendering apparatus of claim 1, wherein the subpixel determination unit determines the subpixel in parallel for each 3D pixel.

11. A subpixel rendering method, comprising:
determining, by a processor, positions of eyes of a user; and
determining, based on the positions of the eyes, a subpixel among a plurality of subpixels forming a three-dimensional (3D) pixel, the subpixel emitting a ray that enters the eyes.

12. The subpixel rendering method of claim 11, wherein the determining of the subpixel comprises determining the subpixel based on horizontal direction information and vertical direction information of a virtual line connecting the 3D pixel to the eyes.

13. The subpixel rendering method of claim 12, wherein the determining of the subpixel comprises calculating a horizontal direction slope of the virtual line and a vertical direction slope of the virtual line.

14. The subpixel rendering method of claim 13, wherein the determining of the subpixel comprises selecting a ray having a slope most similar to the horizontal direction slope and the vertical direction slope, from among rays in different directions emitted from the 3D pixel, and determining a subpixel that emits the selected ray, as a subpixel at which the eye stares.

15. The subpixel rendering method of claim 11, further comprising:
determining a content based on horizontal direction information and vertical direction information of a virtual line connecting the 3D pixel to the eyes, the content being displayed on a light field display; and
determining a pixel value of the determined subpixel, using the determined subpixel and the determined content.

16. The subpixel rendering method of claim 11, further comprising:
reducing a crosstalk between the determined subpixel and the other subpixels, the other subpixels comprising at least one subpixel obtained by excluding the determined subpixel from the plurality of subpixels.

17. The subpixel rendering method of claim 11, further comprising:
capturing the positions of the eyes using at least one camera.

18. The subpixel rendering method of claim 17, wherein the determining of the positions of the eyes comprises determining position coordinate values of the eyes in a space coordinate, using the positions of the eyes captured by the at least one camera, and
wherein the determining of the subpixel comprises determining the subpixel based on the determined position coordinate values, in the light field display.

19. The subpixel rendering method of claim 11, wherein the determining of the subpixel comprises determining the subpixel in parallel for each 3D pixel.

20. A non-transitory computer readable recording medium storing a program to cause a computer to implement the method of claim 11.
